(19) United States
(12) Patent Application Publication
(10) Pub. No.: US 2012/0238306 A1
(43) Pub. Date: Sep. 20, 2012

(54) SYSTEM AND METHOD FOR COMBINING RADIO FREQUENCY (RF) TECHNOLOGIES

(75) Inventor: Michael Evers, Calgary (CA)

(73) Assignee: PRAIRIE PRECISION NETWORK INC., Calgary (CA)

(21) Appl. No.: 13/420,166

(22) Filed: Mar. 14, 2012

Related U.S. Application Data
(60) Provisional application No. 61/452,998, filed on Mar. 15, 2011.

(51) Int. Cl. H04W 24/02

(52) U.S. Cl. 455/515

(57) ABSTRACT

A communications system for allowing a host system such as a GNSS satellite receiver to obtain a data communications connection is provided, comprising: a processor board connecting a cellular module, a WiFi module, and a radio module; and a communications selection means for automatically determining which module is capable of obtaining a data communications connection, wherein the communications selection means includes an algorithm that scans through the modules in a pre-defined order in search of the preferred communications connection, wherein the algorithm includes instructions to stop scanning when a module has found a valid connection. In one embodiment, the communications system further comprises a GNSS module connected to the processor board.

This application claims the benefit of U.S. Provisional Patent Application No. 61/452,998, filed Mar. 15, 2011.

### FIELD OF INVENTION

The present invention relates to a system and method for obtaining a data communications connection in remote areas using a combination of Radio Frequency (RF) technologies. More particularly, a communications system for allowing a host system such as a global navigation satellite systems (GNSS) satellite receiver to obtain a data communications connection is provided comprising a processor board connecting a cellular module, a WiFi module and a radio module.

### BACKGROUND OF THE INVENTION

RF technologies use electromagnetic radiation in the 15 kHz to 300 GHz range to accomplish a wide range of objectives, including broadcasting, two-way communication, manufacturing applications, and security and access control, to name just a few. RF technologies include digital TV and radio, advanced cellular communications, wireless networking, the global navigation satellite systems (GNSS), radio frequency identification (RFID) and PF plasma surface treatment.

By way of example, many vehicles now use global navigation satellite systems, GNSS, which is the generic term for satellite navigation systems that provide autonomous geo-spatial positioning with global coverage. The United States NAVSTAR Global Positioning System (GPS) is one such system. GNSS satellite receivers provide reliable location and time information by calculating its position by precisely timing signals sent by GNSS satellites.

Many GNSS systems are now equipped to receive real-time correction data to provide up to centimeter-level accuracy (commonly called Real Time Kinematic-enabled GNSS system or RTK-enabled GNSS system). Such accuracy is particularly important when the vehicle is a work vehicle such as a tractor pulling a farm implement such as a seeder, where accurate placement of seed, fertilizer and the like is critical to optimize efficiencies.

However, in order to access the RTK data correction of many RTK service providers, it is necessary to receive data obtained through an Internet Protocol (IP) connection, which may be difficult when operating a vehicle in a remote location.

### SUMMARY OF THE INVENTION

In one aspect, the present invention relates to a communications system which can be connected to a host system such as a GNSS satellite receiver. In one embodiment, a communications system for allowing a host system such as a GNSS satellite receiver to obtain a data communications connection is provided, comprising:
a processor board connecting a cellular module, a WiFi module, and a radio module; and
a communications selection means for automatically determining which module is capable of obtaining a data communications connection, wherein the communications selection means includes an algorithm that scans through the modules in a pre-defined order in search of the optimal connection, wherein the algorithm includes instructions to stop scanning when at least one module has found a valid communications connection.

In one embodiment, the algorithm includes instructions to scan the modules and select the preferred communications method.

In another embodiment, the communications system further comprises a GNSS module connected to the processor board for receiving GNSS signals. Many RTK service providers use Network RTK technology that requires the user to periodically send their current position to the RTK service provider. Not all connections to the host, RTK enabled GNSS receiver will be capable of sending their current position to the communications device. Thus, in these cases the communications device will need to use its on-board GNSS module to obtain a current position to send to the RTK service provider.

### DESCRIPTION OF THE DRAWINGS

Referring to the drawings, several aspects of the present invention are illustrated by way of example, and not by way of limitation, in detail in the figures, wherein:

FIG. 1 is a block diagram of one embodiment of a communications system of the present invention.

FIG. 2 is a block diagram of another embodiment of a communications system of the present invention.

FIG. 3 is a diagram showing several communications systems of the present invention communicating with each other in a star configuration.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details. Further, the drawings provided are not necessarily to scale and in some instances proportions may have been exaggerated in order more clearly to depict certain features. Throughout the drawings, from time to time, similar numbers may be used to reference similar, but not necessarily identical, parts.

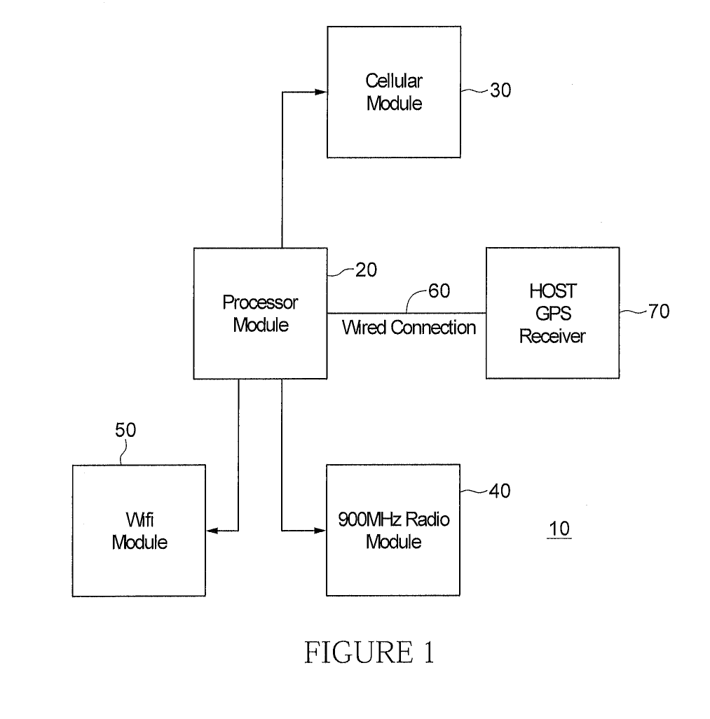

With reference now to FIG. 1, communications system 10 incorporates a processor board/module 20 connecting a cellular module 30, a 900 MHz radio module 40 and a WiFi module 50. The processor board 20 further comprises a wired communication port 60, e.g., RS-232 COM, RS-485, CAN, and/or Ethernet, which can be used to connect to a host system, e.g., a GNSS receiver, 70, installed in a vehicle such as a tractor.

In one aspect, the communications system 10 provides an extremely reliable and robust data communications connection for the host system 70 allowing the host to receive Real Time Kinematic correction data from an RTK service provider. In this embodiment, the host system 70 is a RTK-enabled GNSS system. The processor board will have enough memory and available processor power to run intermediary software such as an NTRIP client for retrieving GNSS RTK correction data from one of the RF connections (cellular module 30, WiFi module 50 or 900 MHz radio module 40) and passing it along to the host system 70 (RTK-enabled GNSS receiver) via the wired connection 60 (i.e., RS232 COM port). In another aspect, the data communications connection can also be used for remote diagnostics, monitoring or configuration as well as inter-vehicle communication, for example, between two tractors, so as to co-ordinate (send/receive) data for variable rate applications, and as-applied or real-time mapping.

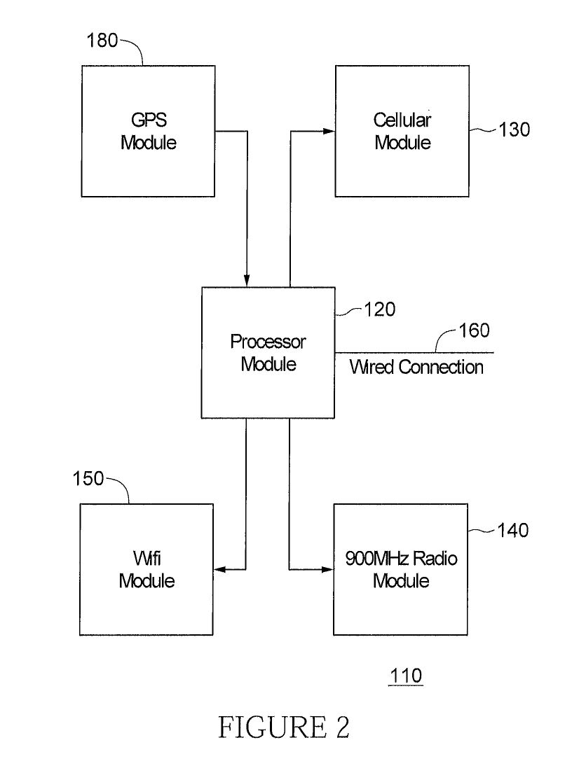

In another embodiment shown in FIG. 2, communications system 110 comprises a processor board/module 120 connecting a cellular module 130, a 900 MHz radio module 140, a WiFi module 150 and a GNSS module 180. The processor board 120 further comprises a wired communication port 160, e.g., RS-232 COM, RS-485, CAN, and/or Ethernet, which can be used to connect to a host system installed in a vehicle such as a tractor (not shown). It is understood that the embodiment shown in FIG. 2 may also be connected to a GNSS receiver as the host device, as shown in FIG. 1. However, in this embodiment, the host system may or may not be a GNSS receiver. By supplying an internal GNSS module 180, positioning on the vehicle is still possible even if positioning information is not available from the host system

There are three methods that a communications system of the present invention can use to send or receive data to and from an external device or system. The data can be sent or retrieved directly over an Internet Protocol (IP) connection using either a cellular data connection or using the WiFi module to connect to a WiFi access point. If neither the cellular connection nor the WiFi connection is desired or available, the communications system will have the ability to send and retrieve data by passing it thru the 900 MHz radio module to a device of the present invention that has an IP connection. If a communications system of the present invention has an IP connection thru either the cellular module or the WiFi module, the 900 MHz radio module will be switched into a “base” mode. The communications system, when acting as the 900 MHz base radio, will have a defined protocol that allows another communications system of the present invention to send and receive Transmission Control Protocol (TCP) packets through it. TCP is one of the core protocols of the Internet Protocol Suite. The base radio may also be configured to automatically broadcast data (e.g., GNSS RTK corrections) to all or some of the remotes connected to it whenever it has an IP connection with either the cell or WiFi modules.

The communications system can be configurable as to whether the cellular or WiFi method is the preferred IP connection. The cellular module may even be disabled. If the cellular module is disabled the communications system will only search for a WiFi access point using the WiFi module for a direct IP connection. Alternatively a communications system with the cellular disabled will search for a 900 MHz base radio to establish communications if a valid WiFi access point cannot be found. Unless disabled, the WiFi module will be set as an endpoint to search for a connection on startup. If the cellular module is the primary module and an IP connection has been established with the cellular module, the WiFi module will automatically switch to be an access point. This will allow other devices to get an IP connection by connecting to this WiFi access point.

In the case where more than one communications system is present on a vehicle or there are two or more vehicles in close proximity to each other, each having a communications system and each needing a data communications connection, the multiple communications system units can be set up to only use one cellular data plan and share the connections. By settings up one communications system with an activated cell data capability, the other units will have the ability to get a data communications connection through the primary unit with either the WiFi connection or the 900 MHz radio connection.

In operation, the communications system will first search for a connection on the primary IP connection (cellular or WiFi). If the primary IP connection fails, the communications system will look for a connection with the secondary IP connection if the secondary method is not disabled. If an IP connection is successful, the communications system will set the 900 MHz radio into base mode and allow other units to send and receive data through it. The 900 MHz radio may be set up as a star configuration to allow for 2-way communications between the base radio and each rover radio. The 900 MHz radio could be used to rebroadcast any RTK correction data received on the base IP connection to one or more rover units nearby that are communicating with the base or it could be used to pass through communications to the internet for the rover units. If neither the cellular nor the WiFi connection were successful, the communications system will switch the 900 MHz radio to rover mode and search for a base radio with which to establish communication. At any time that the communications systems losses its current connection, the above mention search process will restart to reconnect with the best method available.

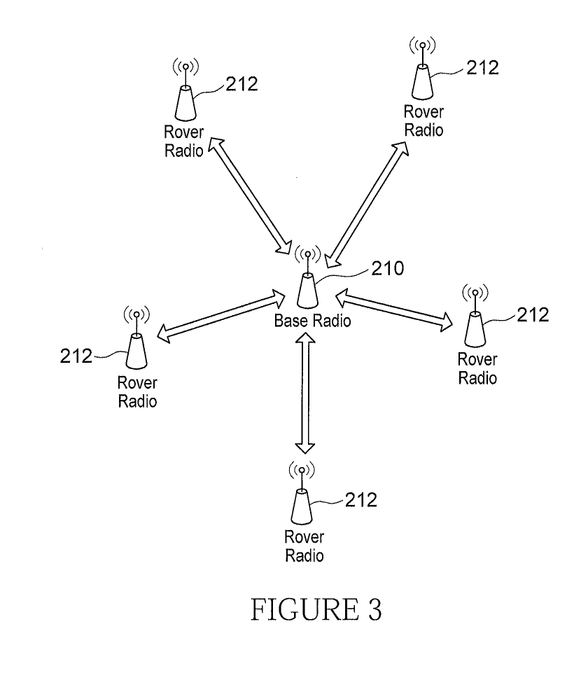

Thus, in one embodiment, the 900 MHz radios of several communications systems of the present invention can communicate with each other in a star configuration, as shown in FIG. 3. In this configuration, the radio module on the communications system with an IP connection is configured as a base radio 210, and the endpoint radios are configured as rover radios 212. The base radio 210 can communicate with any rover radio 212, and any rover radio 212 can communicate with the base radio 210. It is understood that the rover radios 212 can be a communications system of the present invention or any other compatible system having a compatible 900 MHz radio.

The base radio 210 keeps a list of all connected rover radios 212 and rover radios 212 may enter and leave the configuration as necessary. The protocol and procedure for rover radios 212 entering and leaving the star configuration is managed entirely by the radios involved. The base communications system may keep track of specific rover radio parameters such as MAC address, RSSI, battery voltage, and any other operational or statistical information. The base may also control specific rover radio parameters such as transmit power level and any control points.

If during operation a primary communications system looses the IP connection, the 900 MHz radio will stop any transmissions to any rover radios if it was doing so and/or close all communications with all rover units. After closing the connections to the rover units, the 900 MHz radio will switch from base mode to rover mode. In the rover mode, the radio will search for a base radio with which to establish communications. The base communications may be either to receive RTK correction data or to pass through the base for internet communications. The base radio can be from any roving communications system with an IP connection and therefore acting as a mobile 900 MHz base radio.

Alternatively, the base may be a communications system setup on a location with a good cellular connection which can be either a temporary (i.e., on a truck, on a tri-pod, etc) or on a permanent location (i.e., on top of a building, on a tower, etc) with the expressed purpose of acting as a 900 MHz base. This can be used to either enhance the coverage in an area or to share the IP connection with multiple communications system units operating in close proximity to each other.

With the star configuration used in the 900 MHz radios, control can be set to limit which rover communications system units have the ability to communicate with which base units. This method will allow a mechanism to either limit the radio to connect to certain base units and/or to limit the time when they can connect. By limiting the cellular disabled unit's ability to connect to other communications system units acting as base radios, this will provide complete control over who has access to this indirect communications as well as give the provider the ability to offer this indirect access with a reduced price.

In areas where there are known difficulties in getting an IP connection a communications system can be set up in a location where it has an IP connection and can cover the areas with connection difficulties with the 900 MHz radio capabilities. This will allow other rover communications system units to operate in areas with limited or no cellular or WiFi signal.

In this way a communications system of the present invention can be used as a stationary repeater that is set up in an area with an IP connection and rebroadcast the received GNSS RTK corrections with the 900 MHz radio to other communications system units in nearby areas where the IP connection is not accessible. In addition, the communications system will automatically act as a moving repeater whenever an IP connection is established. The 900 MHz radio can be configured to allow only a specified list of communications system's radios to connect and communicate or it can be configured to be “open” allowing any other radio to establish a connection. Thus, the 900 MHz radio on the communications system may have the ability to limit which clients will have access.

The present invention employs an algorithm that scans through the communication modules in a pre-defined order in search of a valid communications connection. The algorithm includes instructions to stop scanning when a communication module has found a valid communications connection. In one embodiment, the algorithm includes instructions to scan the pre-defined communications modules and select the preferred communications method. In another embodiment, the algorithm includes instructions to continue scanning for either a cellular or WiFi connection when the radio module is being used as a rover unit for communications. The continued scanning is in order to switch to one of the preferred methods as soon as they become available. If an internet connection is established using the cellular module, the algorithm may also include instructions to set the WiFi module into an access-point mode. However, if the cellular connection is lost, the algorithm may include instructions to set the WiFi module into end-point mode to again be used to search for a valid connection.

In one embodiment, once either a cellular or WiFi connection has been established, the algorithm will include instructions to set the radio module into a base mode. Thus, when the radio is acting as a base, it will be able to establish communications with one or more rover radios. If the cellular or WiFi connection is lost, the algorithm may include instructions to set the radio module into rover mode to search for a base radio to establish a connection. The radio will continue searching for other base units using a “Received Signal Strength Indicator”, or RRSI, to determine the most desirable base radio to be used. RSSI is a value that will indicate the strength or weakness of the signal of a current connection.

In one embodiment, on connecting to a base radio, the algorithm will use the two way communications to authenticate the rover radio's permission as to whether access to the base radio shall be granted. In another embodiment, on connecting to a base radio, the rover communications system may receive broadcast GNSS RTK correction data from the base communications system. When acting as a base radio, the communications system may pass on GNSS RTK correction data received with an internet connection to one or more of its connected rover units. Upon acting as a base and where access has been granted to a rover radio, the base communications system will be able to forward TCP data packets to and from the rover radio giving the rover an internet connection.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

1. A communications system for allowing a host system such as a GNSS satellite receiver to obtain a data communications connection, comprising:
a processor board connecting a cellular module, a WiFi module, and a radio module; and
a communications selection means for automatically determining which module is capable of obtaining a data communications connection, wherein the communications selection means includes an algorithm that scans through the modules in a pre-defined order in search of an optimal connection, wherein the algorithm includes instructions to stop scanning when at least one module has found a valid communications connection.

2. The communications system as claimed in claim 1, further comprising a GNSS module connected to the processor board for determining the current position of the communication system.

3. The communications system as claimed in claim 1, wherein the algorithm includes instructions to scan the modules and select a preferred communications method.

4. The communications system as claimed in claim 1, wherein the algorithm includes instructions to continue scanning for either a cellular or WiFi connection when the radio module is being used as a rover unit for communications.

5. The communications system as claimed in claim 1, wherein if the communications connection is established using the cellular module the algorithm includes instructions to set the WiFi module into an access-point mode.

6. The communications system as claimed in claim 5, wherein if the cellular connection is lost the algorithm includes instructions to set the WiFi module into end-point mode to be used to search for a valid connection.

7. The communications system as claimed in claim 1, wherein once either a cellular or WiFi connection has been established the algorithm includes instructions to set the radio module into a base mode.

8. The communications system as claimed in claim 7, wherein the radio module acting as a base will be able to establish two-way communications with one or more rover radios.

9. The communications system as claimed in claim 7, wherein the radio module acting as a base will be able to broadcast data to any rover radio currently connected.

10. The communications system as claimed in claim 1, wherein if a connection cannot be made using the cellular module or the WiFi module, the algorithm includes instructions to set the radio module into rover mode to search for a base radio to establish a data communications connection.

11. The communications system as claimed in claim 10, wherein the radio module continues searching for other base units using the RRSI to determine the most desirable base radio to be used.

12. The communications system as claimed in claim 10, wherein on connecting to the base radio the algorithm includes instructions to obtain permission from the base radio to access the base radio.

13. The communications system as claimed in claim 10, wherein on connecting to the base radio the algorithm includes instructions to obtain GNSS RTK correction data from the base radio.

14. The communications system as claimed in claim 1, wherein when the communications system is acting as a base radio, the communications system can pass on GNSS RTK correction data received with the connection to one or more rover radios.

15. The communications system as claimed in claim 1, wherein when the communications system is acting as a base radio and access has been granted to a rover radio, the communications system will be able to forward TCP data packets to and from the rover radio thereby giving the rover radio an IP connection.
